(19) United States
(12) Patent Application Publication
(10) Pub. No.: US 2026/0347179 A1
(43) Pub. Date: Nov. 5, 2026

(54) APPARATUS AND METHOD FOR IODINE RECOVERY

(71) Applicants: SK INNOVATION CO., LTD., Seoul (KR); SK ON CO., LTD., Seoul (KR)

(72) Inventors: Ji Sup SHIN, Daejeon (KR); Soo Kil KANG, Daejeon (KR); Dong Keun KIM, Daejeon (KR); Seung Ok LEE, Daejeon (KR); Ho Won LEE, Daejeon (KR); Hee Du LEE, Daejeon (KR); Jong Woo LIM, Daejeon (KR); Ju Hwan IM, Daejeon (KR); Jae Hun JEONG, Daejeon (KR)

(21) Appl. No.: 19/467,795

(22) Filed: Feb. 3, 2026

(30) Foreign Application Priority Data
Apr. 30, 2025 (KR) 10-2025-0057477
Aug. 20, 2025 (KR) 10-2025-0116035

(51) Int. Cl. C01B 7/14; B01D 53/00

(52) U.S. Cl. CPC C01B 7/14; B01D 53/002; B01D 2257/2068

(57) ABSTRACT

The present disclosure relates to an apparatus and method for iodine recovery. An apparatus for iodine recovery may include a condenser configured to cool a reactor effluent and separate the reactor effluent into liquid iodine and a gas, a liquid iodine recovery reclaimer connected to a lower portion of the condenser and configured to recover the separated liquid iodine, a gas discharger connected to an upper portion of the condenser and configured to discharge the separated gas, a desublimator connected to the gas discharger, and a recirculation line configured to re-supply liquid iodine recovered in the desublimator to the condenser.

### CROSS-REFERENCE TO RELATED APPLICATION

This application claims priority to Korean Patent Application No. 10-2025-0057477 filed Apr. 30, 2025, and Korean Patent Application No. 10-2025-0116035 filed Aug. 20, 2025, the disclosures of which are hereby incorporated by reference in their entireties.

### BACKGROUND

### Technical Field

The embodiments of the present disclosure relate generally to an apparatus and method for iodine recovery, and more particularly, to an apparatus and method for iodine recovery through iodine liquefaction.

### Technical Considerations

Iodine is a high value-added material used in various chemical processes, and there is a need for a technology to efficiently recover iodine contained in a reactor effluent.

Conventionally, a process of recovering iodine by desublimation from a gaseous state has been used. However, this method involves a large cooling load and increases the size of the apparatus. In addition, iodine recovered as a solid requires high energy consumption during reheating, resulting in low thermal efficiency.

### SUMMARY

Embodiments of the present disclosure may provide an apparatus and method for iodine recovery, capable of efficiently recovering iodine in a liquefied state.

According to an embodiment of the present disclosure, there is provided an apparatus for iodine recovery, the apparatus comprising a condenser configured to cool a reactor effluent and separate the reactor effluent into liquid iodine and a gas; a liquid iodine recovery reclaimer connected to a lower portion of the condenser and configured to recover the separated liquid iodine; a gas discharger connected to an upper portion of the condenser and configured to discharge the separated gas; a desublimator connected to the gas discharger; and a recirculation line configured to re-supply liquid iodine recovered in the desublimator to the condenser.

In some non-limiting embodiments, the condenser may include a packing section formed therein, and the reactor effluent and the liquid iodine supplied through the recirculation line may contact each other in the packing section.

In some non-limiting embodiments, the packing section may be disposed in a central portion of the condenser and may be spaced apart from an inner wall of the condenser.

In some non-limiting embodiments, the condenser may include a baffle vertically installed inside the condenser adjacent to the packing section, and configured to partition a region where the liquid iodine inside the condenser collects and a region where the gas stays before being discharged to the gas discharger.

In some non-limiting embodiments, the baffle may extend from the upper portion toward the lower portion inside the condenser, and may define a lower space spaced apart from a bottom region of the condenser.

In some non-limiting embodiments, the condenser may include a chimney tray formed in the upper portion of the condenser and configured to collect condensed liquid iodine, and the apparatus may further comprise a downcomer configured to guide the liquid iodine collected in the chimney tray to the bottom region of the condenser.

In some non-limiting embodiments, the liquid iodine recovery reclaimer may include a liquid iodine outlet connected to the bottom region of the condenser.

In some non-limiting embodiments, the gas discharger may include a gas outlet formed on an upper side surface of the condenser.

In some non-limiting embodiments, the desublimator may be configured to recover iodine remaining in the gas supplied from the gas discharger as liquid iodine, and to supply the recovered liquid iodine to the recirculation line.

In some non-limiting embodiments, the recirculation line may be a pipe connecting a lower outlet of the desublimator and an upper inlet of the condenser.

According to another embodiment of the present disclosure, there is provided a method for iodine recovery, the method comprising cooling a reactor effluent in a condenser to separate the reactor effluent into liquid iodine and a gas; recovering the separated liquid iodine through a liquid iodine recovery reclaimer connected to a lower portion of the condenser, discharging the separated gas through a gas discharger connected to an upper portion of the condenser, recovering iodine remaining in the gas as liquid iodine in a desublimator connected to the gas discharger; and re-supplying the liquid iodine recovered in the desublimator to the condenser through a recirculation line.

In some non-limiting embodiments, the operation of cooling the reactor effluent in a condenser to separate the reactor effluent into liquid iodine and a gas may comprise contacting the reactor effluent with the liquid iodine supplied through the recirculation line in a packing section formed inside the condenser and accommodating a plurality of packing materials.

In some non-limiting embodiments, the method may further comprise partitioning a region where the liquid iodine inside the condenser collects and a region where the gas stays before being discharged to the gas discharger using a baffle vertically installed inside the condenser adjacent to the packing section.

In some non-limiting embodiments, the baffle may extend from the upper portion toward the lower portion inside the condenser to define a lower space spaced apart from a bottom region of the condenser, and the method may further comprise flowing the gas to the gas discharger through the lower space of the baffle.

In some non-limiting embodiments, the operation of recovering the separated liquid iodine through a liquid iodine recovery reclaimer connected to a lower portion of the condenser may comprise discharging the liquid iodine through a liquid iodine outlet formed in a bottom region of the condenser.

In some non-limiting embodiments, the operation of re-supplying the liquid iodine recovered in the desublimator to the condenser through a recirculation line may comprise supplying the liquid iodine to the packing section inside the condenser through the recirculation line connecting a lower outlet of the desublimator and an upper inlet of the condenser.

In some non-limiting embodiments, the condenser may include a chimney tray formed in the upper portion of the condenser and configured to collect condensed liquid iodine, and the method may further comprise guiding the liquid iodine collected in the chimney tray to a bottom region of the condenser through a downcomer to discharge the liquid iodine.

In some non-limiting embodiments, iodine may be effectively recovered by liquefying and recovering the iodine, thereby reducing a burden on downstream equipment.

In some non-limiting embodiments, since the iodine recovered in the condenser exists in a liquid state, storage and transport thereof may be facilitated compared to iodine recovered in a solid state, and the recovered iodine may be directly supplied to and utilized in a reuse process.

### BRIEF DESCRIPTION OF THE DRAWINGS

The above and other objects, features and other advantages of the embodiments of the present disclosure will be more clearly understood from the following detailed description taken in conjunction with the accompanying drawings, in which:

FIG. 1 is a process flow diagram illustrating an iodine recovery and recirculation process according to some non-limiting embodiments of the present disclosure.

FIG. 2 is a schematic diagram illustrating a structure of a condenser of an apparatus for iodine recovery according to some non-limiting embodiments of the present disclosure.

FIG. 3 is a flowchart illustrating a method for iodine recovery according to some non-limiting embodiments of the present disclosure.

### DETAILED DESCRIPTION

Hereinafter, embodiments of the present disclosure will be described in detail with reference to the accompanying drawings. However, since various changes may be made to the embodiments, the scope of the present disclosure is not limited or restricted by these embodiments. It should be understood that all modifications, equivalents, and alternatives for the embodiments are within the scope of the present disclosure. For example, it is to be understood that the embodiments include various alternative variations and step sequences, except where expressly specified to the contrary. It is also to be understood that the specific devices and processes illustrated in the attached drawings, and described in the following detailed description, are simply illustrative of the of the disclosed subject matter. Hence, specific dimensions and other physical characteristics related to the embodiments disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “comprise”, “comprises”, “comprising”, “include”, “includes”, “including”, “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments, refer to a condition for automatically triggering an action (e.g., a specific operation of an electronic device, such as a computing device, a processor, and/or the like).

It will be understood that when a component is described to as being “connected,” “combined” or “coupled” to another component, the component may be directly connected or coupled to the other component, but it may be “connected,” “combined” or “coupled” to the other component by an intervening another component that may be present.

Further, in describing the components of an embodiment, the meaning of “or” may mean each of the components, may mean two or more of the components, or may mean all of the components. For example, it should be understood that the expressions “a, b orc” represent any one of“a,” “b,” “c,” “a and b,” “a and c,” “b and c,” and “a, b and c.”

Components comprised in one embodiment and components comprising common functions will be described using the same names in other embodiments. The description given in one embodiment may be applied to other embodiments, and therefore will not be described in detail within the overlapping range, unless there is a description opposite thereto.

The device and/or ‘data’ processed by the device may be expressed in terms of ‘information”. Here, the information may be used as a concept comprising the data.

The embodiments of the present disclosure relate to an apparatus for iodine recovery configured to recover iodine vapor contained in a reactor effluent by liquefying the iodine vapor.

The reactor effluent includes iodine vapor and non-condensable gas. By supplying the reactor effluent to a condenser and cooling the reactor effluent, the reactor effluent may be separated into liquid iodine and a gas.

In this case, an inside of the condenser is preferably maintained at a pressure sufficient for iodine to be liquefied (e.g., 4 kg/cm²g) and at a low temperature at which iodine is not re-vaporized (e.g., 160 °C or lower).

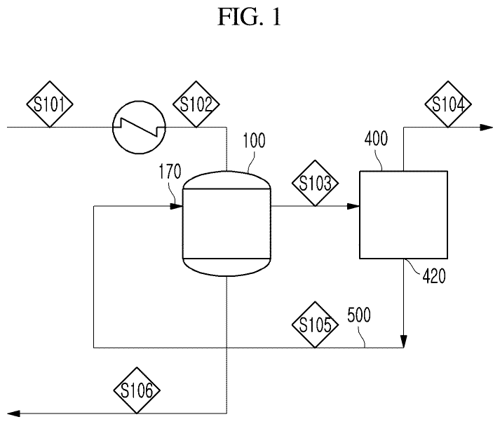

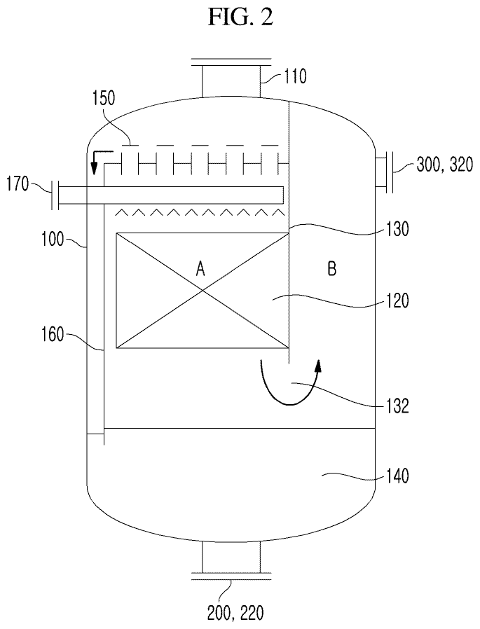

FIG. 1 is a process flow diagram illustrating an iodine recovery and recirculation process according to an embodiment of the present disclosure. FIG. 2 is a schematic diagram illustrating a structure of a condenser of an apparatus for iodine recovery according to an embodiment of the present disclosure.

As shown in FIGS. 1 and 2, the apparatus for iodine recovery according to an embodiment of the present disclosure includes a condenser 100 configured to cool a reactor effluent S101 and separate the reactor effluent S101 into liquid iodine and a gas, a liquid iodine recovery reclaimer 200 connected to a lower portion of the condenser 100 and configured to recover the separated liquid iodine, a gas discharger 300 connected to an upper portion of the condenser 100 and configured to discharge the separated gas, a desublimator 400 connected to the gas discharger 300, and a recirculation line 500 configured to re-supply liquid iodine recovered in the desublimator 400 to the condenser 100.

The condenser 100 according to the embodiment of the present disclosure is configured to receive and cool the reactor effluent S101, thereby converting iodine vapor in the reactor effluent into liquid iodine and separating non-condensable gas.

According to an embodiment, the inside of the condenser 100 may be maintained at a pressure at which iodine may be stably liquefied, for example, approximately 4 kg/cm²g, and at the same time, may be maintained at approximately 160 °C or lower so that iodine is not re-vaporized.

According to an embodiment of the present disclosure, a packing section 120 accommodating a plurality of packing materials may be formed inside the condenser 100 so that the reactor effluent and the liquid iodine supplied through the recirculation line 500 contact each other.

According to an embodiment of the present disclosure, the packing section 120 may be formed inside the condenser 100. The packing section 120 may include a plurality of packing materials where the reactor effluent and the liquid iodine supplied through the recirculation line 500 contact each other to perform heat exchange.

The packing section 120 according to an embodiment of the present disclosure is generally disposed in a central portion of the condenser 100 and may be installed spaced apart from an inner wall of the condenser 100. That is, the packing section 120 may be disposed to provide a space sufficient for a gas flow and a liquid flow to collide with and contact each other. In the packing section 120, a gas passes vertically and contacts surfaces of the plurality of packing materials to increase a contact area, and the liquid iodine is dispersed and flows along the packing materials to perform heat exchange.

The packing section 120 according to an embodiment of the present disclosure may comprise packing materials of various shapes and materials. For example, ring-type packing materials, rectangular lattice-type packing materials, or irregular packing materials made of a metal material, a ceramic material, or a plastic material may be used. These packing materials may increase contact between the gas and the liquid through a plurality of surfaces and promote condensation of iodine vapor.

Referring to FIG. 2, the packing section 120 according to an embodiment of the present disclosure may be disposed in a passage through which the gas flows from an upper portion to a lower portion of the condenser 100, and may be disposed in a passage through which the liquid iodine supplied from the recirculation line 500 is dispersed from the upper portion and flows along the surfaces of the packing materials.

Accordingly, the packing section 120 according to an embodiment of the present disclosure is designed to efficiently exchange heat between the reactor effluent and the recirculated liquid iodine, and may increase a time during which the gas stays inside the condenser 100 and contacts the liquid iodine.

According to an embodiment of the present disclosure, the packing section 120 is operated under a pressure condition of about 4 kg/cm²g and a temperature condition of about 160 °C or lower, and the liquid iodine supplied through the recirculation line 500 is dispersed from the upper portion and flows along the packing materials to contact the reactor effluent.

As a result, according to an embodiment of the present disclosure, a contact area between the reactor effluent and the recirculated liquid iodine is expanded, so that condensation efficiency of iodine vapor is improved, and iodine remaining in the gas may be effectively recovered.

The packing section 120 according to an embodiment of the present disclosure may be disposed in a central portion of the condenser 100 and may be installed spaced apart from an inner wall of the condenser 100.

The packing section 120 may be installed spaced apart from the inner wall of the condenser 100 at a predetermined gap. This spaced arrangement induces the gas to efficiently pass through the packing section 120 inside the condenser 100, and the gap formed between the inner wall of the condenser 100 and the packing section 120 allows flows of the gas and the liquid to be stably maintained.

That is, when a flow path having the predetermined gap is formed between an outer circumference of the packing section and the inner wall of the condenser, the reactor effluent does not simply pass through the packing section linearly, but a part of the fluid flows along the outer flow path and may rejoin toward the packing section. This allows the flow to be uniformly dispersed so that the entire area of the packing section is evenly used, and local flow velocity concentration or a dead zone may be reduced.

In an embodiment of the present disclosure, when the inside of the condenser 100 has a cylindrical structure with a constant diameter, a flow path having a predetermined gap may be formed between the outer circumference of the packing section 120 and the inner wall of the condenser 100. Through this arrangement, the reactor effluent supplied from the upper portion of the condenser 100 passes through the plurality of packing materials formed in the packing section 120 to perform heat exchange, and a contact time between the liquid iodine flowing downward inside the condenser 100 and the gas may be increased.

As described above, since the packing section 120 according to an embodiment of the present disclosure is disposed in the central portion of the condenser 100 and installed spaced apart from the inner wall, a contact area between the gas and the liquid is expanded while the reactor effluent passes through the packing section 120, condensation efficiency of iodine vapor is improved, and iodine remaining in the gas may be more effectively converted into a liquid phase. Accordingly, an iodine recovery rate may increase.

Inside the condenser 100 according to an embodiment of the present disclosure, a baffle 130 is vertically installed (in a direction from the upper portion to the lower portion of the condenser) adjacent to the packing section 120, so that a region A where the liquid iodine inside the condenser 100 collects and a region B where the gas stays before being discharged to the gas discharger 300 may be partitioned.

The baffle 130 may be disposed adjacent to the packing section 120 within the internal flow path of the condenser 100. The baffle 130 extends long in the vertical direction and may partition an inner space of the condenser 100 to separate the inner space into two different regions.

The baffle 130 may be vertically installed adjacent to the packing section 120. The packing section 120 is a region where the plurality of packing materials are accommodated and the reactor effluent contacts the liquid iodine supplied through the recirculation line 500, and the baffle 130 is disposed at a position close to this region to determine a path through which the gas having passed through the packing section 120 stays inside the condenser 100.

Referring to FIG. 2, the baffle 130 may be formed in a flat plate shape or a curved plate shape installed between the outside of the packing section 120 and the inner wall of the condenser 100, and may extend in the vertical direction.

By installing the baffle 130, the inside of the condenser 100 may be partitioned into two regions. A first region is the region A where liquid iodine is generated, and a second region is the region B where the gas remaining after heat exchange (non-condensable gas) stays before being discharged to the gas discharger 300. Here, the region A where liquid iodine is generated refers to a region where liquid iodine temporarily stays immediately after condensation (or immediately after heat exchange). The baffle 130 physically partitions these two regions so that the reactor effluent sufficiently stays and contacts the liquid iodine. Accordingly, the liquid iodine may temporarily stay in the region A and then be stably collected in the bottom region 140, and the remaining gas may be discharged to the gas discharger 300.

In a specific embodiment, the baffle 130 inside the condenser 100 is vertically installed from the upper portion to the lower portion of the condenser 100, and a predetermined gap is formed between the baffle 130 and the bottom of the condenser 100 so that the non-condensable gas passes through a lower space 132 and flows to the gas discharger 300. For example, the baffle 130 is vertically disposed outside the packing section 120, and a space 132 may be left between the baffle 130 and the bottom region 140 at a lower portion thereof to maintain the flow of the gas.

The baffle 130 arranged as described above prevents the gas (reactor effluent) from being discharged in a non-condensed state inside the condenser 100, and allows the liquid iodine to be stably collected from the region A to the bottom region 140 of the condenser 100.

According to an embodiment of the present disclosure, the condenser 100 may include a liquid-collection structure, for example, chimney tray 150, formed in an upper portion thereof to collect condensed liquid iodine, and a downcomer 160 configured to guide the liquid iodine collected in the chimney tray 150 to a bottom region 140 of the condenser 100.

According to an embodiment of the present disclosure, the chimney tray 150 may be formed in the upper portion of the condenser 100. The chimney tray 150 is located in the upper portion inside the condenser 100 and may temporarily collect liquid iodine condensed while the reactor effluent is cooled.

According to an embodiment of the present disclosure, the downcomer 160 configured to guide the liquid iodine collected in the chimney tray 150 to the bottom region 140 of the condenser 100 may be included inside the condenser. The downcomer 160 is a pipe-shaped structure coupled to the chimney tray 150 and extending in a downward direction, and may guide the liquid iodine collected on the upper portion of the chimney tray 150 to the bottom region 140 of the condenser 100 by moving the liquid iodine in a direction of gravity.

Here, the bottom region 140 refers to a space within the condenser 100 from a bottom surface of the condenser 100 to a predetermined height of the condenser 100, where the recovered liquid iodine is stored and discharged. It refers to a lower storage space where the liquid iodine collected inside the baffle 130 in the condenser 100 is finally stored.

The downcomer 160 is connected to a bottom surface of the chimney tray 150 so that the liquid iodine moves downward quickly without staying on the upper portion of the chimney tray. This prevents the liquid iodine from staying in the upper region for a long time and being re-vaporized, and allows the liquid iodine to be stably accumulated in the lower region (the bottom region).

According to an embodiment of the present disclosure, the chimney tray 150 may be formed of a metal having corrosion resistance and heat resistance, such as, for example, stainless steel. In addition, a plurality of through-holes may be formed at equal intervals. The through-holes may have a diameter in a range of several millimeters (mm) to several tens of millimeters (mm). One or more downcomers 160 may be installed per chimney tray 150, installed to correspond to the arrangement of the chimney tray 150, and a diameter thereof may be formed to be around several centimeters (cm).

As described above, according to an embodiment of the present disclosure, by including the chimney tray 150 and the downcomer 160, the liquid iodine condensed inside the condenser 100 does not remain in the upper region but quickly gathers in the bottom region 140, and may be stably recovered through the liquid iodine recovery reclaimer 200.

In addition, only pure gas having passed through the chimney tray 150 is transferred to the packing section 120, and an iodine recovery rate may be increased through heat exchange with the cooled iodine being recirculated.

The liquid iodine recovery reclaimer 200 according to an embodiment of the present disclosure is connected to a lower portion of the condenser 100 and serves to discharge and recover the liquid iodine separated inside the condenser 100 to the outside.

The liquid iodine recovery reclaimer 200 may be coupled to the lower portion of the condenser 100 to stably recover the liquid iodine separated in the condenser 100 to the outside. The liquid iodine recovery reclaimer 200 may include a liquid iodine outlet 220 configured to guide the liquid iodine accumulated in the bottom region 140 inside the condenser 100 to the outside. The liquid iodine outlet 220 may be formed integrally with the condenser 100 or may be connected to the bottom region 140 of the condenser 100 through a separate pipe.

The bottom region 140 of the condenser 100 is apart where liquid iodine collects and is stored inside the condenser 100. The bottom region 140 has a structure in which the liquid iodine separated via the packing section 120 and the baffle 130 collects naturally by gravity. A liquid iodine outlet 220 is formed in the bottom region 140 to discharge a stream S106 of the internal liquid iodine to the outside, and the liquid iodine outlet 220 may be installed to be directly connected to the lower portion of the condenser 100 as a part of the liquid iodine recovery reclaimer 200.

According to an embodiment of the present disclosure, the liquid iodine outlet 220 is formed of a metal material having excellent heat resistance and corrosion resistance, and may be disposed to be directly connected to the bottom region 140 of the condenser 100. A diameter of the liquid iodine outlet 220 may be designed according to a flow rate of liquid iodine required in an actual process. In addition, the liquid iodine outlet 220 may include a valve or a flow rate controller to recover the liquid iodine to an external storage unit.

As described above, by including the liquid iodine recovery reclaimer 200, the liquid iodine separated in the condenser 100 may be immediately guided from the bottom region 140 to the outside via stream S106. This prevents the liquid iodine from excessively staying inside the condenser 100 to be re-vaporized or increase a heat load, and allows the liquid iodine to be quickly moved to a downstream storage unit or transportation unit.

The gas discharger 300 according to an embodiment of the present disclosure is connected to the upper portion of the condenser 100 and serves to discharge a stream S103 of non-condensable gas not condensed in the condenser 100 to the outside.

The gas discharger 300 according to an embodiment of the present disclosure is connected to an upper region inside the condenser 100, and may include a pipe and a connection part for guiding the non-condensable gas to the desublimator 400 while maintaining an internal pressure of the condenser 100.

The gas discharger 300 according to an embodiment of the present disclosure may include a gas outlet 320 formed on an upper side surface of the condenser 100.

The gas outlet 320 is disposed at a location on the upper side surface of the condenser 100 where the non-condensable gas, having passed through the packing section 120 and the baffle 130 inside the condenser 100, collects, thereby efficiently discharging the gas to the outside.

The gas outlet 320 may be formed in the shape of a pipe having a circular cross-section, and may be installed to penetrate through a thickness of an upper outer wall of the condenser 100. The gas outlet 320 is coupled to a pipe connected to the outside of the condenser 100, and a valve or a sensor for controlling a gas flow may be added thereto.

According to an embodiment of the present disclosure, a diameter of the gas outlet 320 may be designed in consideration of an expected gas flow rate and pressure loss inside the condenser 100. In addition, a pressure sensor capable of measuring the internal pressure of the condenser 100 and a gas discharge amount in real time may be mounted on the gas outlet 320.

As described above, an embodiment of the present disclosure includes the gas discharger 300 and the gas outlet 320, thereby quickly and stably discharging the non-condensable gas not condensed inside the condenser 100 to the outside. Through this, the internal pressure of the condenser 100 may be maintained constantly, gas discharge is performed smoothly so that heat exchange efficiency inside the condenser 100 is stably maintained, and continuity of the iodine recovery process may be secured.

The desublimator 400 according to an embodiment of the present disclosure is connected to the gas discharger 300 and may additionally recover iodine remaining in the gas discharged from the condenser 100, which has not yet been condensed, as liquid iodine.

The desublimator 400 is a device configured to cool a high-temperature gas to directly sublime a specific component into a solid or recover the specific component as a liquid. In an embodiment of the present disclosure, the desublimator 400 is configured to re-treat iodine vapor remaining in the non-condensable gas discharged from the condenser 100 to recover the iodine vapor as liquid iodine, and re-supply the recovered liquid iodine to the condenser 100 through the recirculation line 500. Through this, an iodine recovery rate may be increased and process loss may be reduced.

The desublimator 400 according to an embodiment of the present disclosure may recover iodine remaining in the gas supplied from the gas discharger 300 as a liquid phase and supply the recovered iodine to the recirculation line 500.

The desublimator 400 may be connected to the gas discharger 300 to receive the outflow of gas S103 discharged from the condenser 100. The gas introduced through the gas discharger 300 includes gas not fully condensed inside the condenser 100, and a trace amount of iodine may remain in this gas. The desublimator 400 serves to additionally treat such gas to recover the remaining iodine in a liquid phase.

The desublimator 400 may be formed of a metal material, and a cooling coil or a heat transfer unit may be included therein to promote heat exchange with the gas.

Specifically, the gas introduced through the gas discharger 300 is cooled through heat exchange inside the desublimator 400, and in this process, the remaining iodine is converted into a liquid phase and collected. This process is similar to condensation, but optimized heat exchange conditions may be used to more efficiently capture iodine finely contained in the gas. For example, the inside of the desublimator 400 may be designed to be maintained at a temperature of about 40 °C or lower, and an internal pressure thereof may be controlled to be maintained substantially the same as that of the condenser 100.

The liquid iodine recovered in the desublimator 400 may be supplied to the condenser 100 through the recirculation line 500. The recirculation line 500 is formed of a pipe structure connecting a lower outlet 420 of the desublimator 400 and an upper inlet 170 of the condenser 100, and the liquid iodine recovered in the desublimator 400 is re-supplied to the condenser 100 to perform additional heat exchange.

According to an embodiment of the present disclosure, the desublimator 400 may be installed in the same process line as the condenser 100, and may be designed such that gas flows in through the gas discharger 300. A plurality of heat exchange panels are disposed inside the desublimator 400 to maximize a heat transfer area with the gas, and an inclined collector configured to efficiently collect the liquid iodine may be provided. A storage for collecting the liquid iodine is formed in a lower portion of the desublimator 400, and transfers the liquid iodine to the recirculation line 500.

As described above, by the desublimator 400 and the recirculation line 500 according to an embodiment of the present disclosure, the remaining iodine not completely recovered in the condenser 100 may be additionally recovered, thereby improving the iodine recovery rate.

The recirculation line 500 according to an embodiment of the present disclosure is a pipe formed to supply liquid iodine recovered in the desublimator 400 back to the condenser 100, and may be formed as a pipe connecting a lower outlet 420 coupled to a lower portion of the desublimator 400 and an upper inlet 170 formed in an upper portion of the condenser 100.

Accordingly, the liquid iodine recovered through the recirculation line 500 is re-supplied into the condenser 100, thereby increasing heat exchange efficiency inside the condenser 100. Also, the recirculation line 500 may increase a partial pressure of iodine inside the condenser 100 to promote condensation of iodine vapor.

According to an embodiment, the recirculation line 500 may be formed as a pipe connecting the lower outlet 420 of the desublimator 400 and the upper inlet 170 of the condenser 100.

The recirculation line 500 is a pipe connecting between the desublimator 400 and the condenser 100 in the iodine recovery apparatus, and serves to supply the liquid iodine recovered from the gas outflow S103 transferred to the desublimator 400 through the gas discharger 300 back to the condenser 100.

Liquid iodine flows inside the recirculation line 500, and therefore the recirculation line 500 may be made of a material having corrosion resistance and heat resistance to prevent leakage to the outside and stably maintain an internal pressure. For example, a pipe made of stainless steel or a high corrosion-resistant alloy material may be applied.

Referring to FIG. 1, a storage configured to collect liquid iodine condensed from the gas may be formed in the lower portion of the desublimator 400, and the lower outlet 420 is installed in this storage, and the recirculation line 500 may be connected thereto. Also referring to FIG. 1, the recirculation line 500 starts from the lower outlet 420 and extends to the upper portion of the condenser 100 to be connected thereto. A separate upper inlet 170 is provided in the upper portion of the condenser 100, so that the liquid iodine supplied through the recirculation line 500 may be supplied to the inside of the condenser 100, particularly to the packing section 120.

According to an embodiment of the present disclosure, a flow rate control valve or a check valve may be added inside the recirculation line 500. In addition, an inner diameter of the recirculation line 500 may be designed according to a supply amount of the liquid iodine recovered in the desublimator 400 and a heat exchange requirement in the packing section 120 inside the condenser 100. A temperature sensor or a pressure sensor may be added to the recirculation line 500 to detect an operation state in real time, thereby maintaining stable recirculation.

Such a recirculation structure increases a partial pressure of iodine inside the condenser 100 and serves as a cooling medium, thereby improving condensation efficiency of iodine vapor.

As described above, the apparatus for iodine recovery according to an embodiment of the present disclosure may efficiently treat the reactor effluent and stably recover iodine as a liquid phase. Through this, compared to the conventional method of recovering iodine as a solid, energy efficiency is high, iodine loss in the process can be reduced, and operation in subsequent storage and reuse processes can be facilitated.

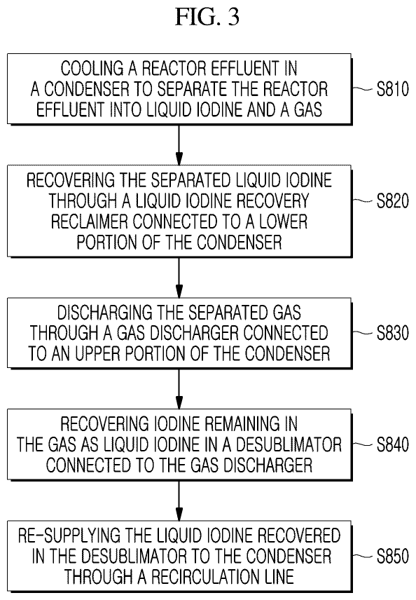

FIG. 3 is a flowchart illustrating a method for iodine recovery according to an embodiment of the present disclosure. Descriptions of parts overlapping with the above-described embodiment will be briefly described or omitted.

As illustrated, the method for iodine recovery according to an embodiment of the present disclosure may include cooling a reactor effluent in a condenser to separate the reactor effluent into liquid iodine and a gas (S810), recovering the separated liquid iodine through a liquid iodine recovery reclaimer connected to a lower portion of the condenser (S820), discharging the separated gas through a gas discharger connected to an upper portion of the condenser (S830), recovering iodine remaining in the gas as liquid iodine in a desublimator connected to the gas discharger (S840) and re-supplying the liquid iodine recovered in the desublimator to the condenser through a recirculation line (S850).

The operation of cooling the reactor effluent in a condenser to separate the reactor effluent into liquid iodine and a gas (S810) according to an embodiment of the present disclosure is a process of supplying iodine vapor and non-condensable gas contained in the reactor effluent discharged from the reactor into the condenser and cooling the same, thereby separating the reactor effluent into liquid iodine and a gas inside the condenser.

The condenser may be operated while maintaining an internal pressure at a pressure sufficient for iodine to be liquefied (e.g., about 4 kg/cm²g) and maintaining an internal temperature at a low temperature (e.g., 160 °C or lower) at which iodine is not re-vaporized.

In an embodiment of the present disclosure, a packing section is installed inside the condenser, so that the reactor effluent and the liquid iodine supplied through the recirculation line contact each other in a region where a plurality of packing materials are accommodated, thereby performing heat exchange. Accordingly, iodine vapor may be more efficiently condensed into liquid iodine.

Next, the operation of recovering the separated liquid iodine through a liquid iodine recovery reclaimer connected to a lower portion of the condenser (S820) is a process of stably recovering the liquid iodine condensed inside the condenser to the outside.

A bottom region is formed in the lower portion of the condenser to collect the liquid iodine, and the liquid iodine recovery reclaimer connected to a liquid iodine outlet may be installed in the bottom region. The liquid iodine inside the condenser may be transferred to an external storage unit or transferred to a subsequent process through the liquid iodine recovery reclaimer.

Next, the operation of discharging the separated gas through a gas discharger connected to an upper portion of the condenser (S830) is a process of discharging the non-condensable gas remaining without being condensed inside the condenser to the outside.

A gas outlet is formed on an upper side surface of the condenser, and the gas discharger including the gas outlet may be connected to an external discharge line. The gas inside the condenser is discharged to the outside through the gas discharger, and this gas may still contain some iodine.

Next, the operation of recovering iodine remaining in the gas as liquid iodine in a desublimator connected to the gas discharger (S840) is a process of supplying the gas transferred from the gas discharger into the desublimator to additionally condense or sublime the remaining iodine in the gas to recover the iodine as liquid iodine.

The desublimator is provided with a separate heat exchange device or a cooling device, so that iodine vapor in the gas may be efficiently converted into liquid iodine. In one embodiment, a storage in which the recovered liquid iodine is stored and a lower outlet may be disposed in a lower portion of the desublimator.

Next, the operation of re-supplying the liquid iodine recovered in the desublimator to the condenser through a recirculation line (S850) is a process of re-supplying the liquid iodine recovered from the lower portion of the desublimator to the upper portion of the condenser through the recirculation line. The recirculation line connects the lower outlet of the desublimator and an upper inlet of the condenser, and may be formed of a pipe structure through which liquid iodine flows. Through this, the recirculated liquid iodine is supplied to the packing section inside the condenser and may be recycled for heat exchange and condensation.

As described above, the iodine recovery method of the present disclosure enables maximum recovery of liquid iodine by sequentially treating the reactor effluent. Through this multi-operation process, iodine is more efficiently liquefied, collected, and recirculated. As a result, the overall iodine recovery rate increases, energy loss is minimized, and the efficiency of the entire process is improved.

Table 1 below shows stream data of the apparatus for iodine recovery (refer to FIG. 1) according to an embodiment of the present disclosure.

TABLE 1

| | | | | | | Mass | | | |
|---|---|---|---|---|---|---|---|---|---|
| | | | Mole | Mass | | Flow | Non- | Liquid | |
| | Temp. | Pressure | Vapor | Density | Average | Rate | condensable | Iodine | |
| Stream | (°C) | (kg/cm²g) | Fraction | (kg/m³) | MW | (kg/hr) | Gas (kg/hr) | (kg/hr) | Remarks |
| S101 (Reactor | 525 | 5.0 | 1.0 | 9.2 | 102.5 | 500.2 | 285.6 | 214.7 | Supplied |
| effluent) | | | | | | | | | from reactor |
| | | | | | | | | | to condenser |
| S102 (Condenser | 160 | 4.0 | 0.91 | 15.7 | 102.5 | 500.2 | 285.6 | 214.7 | Introduced |
| inlet gas) | | | | | | | | | into |
| | | | | | | | | | condenser |
| S103 (Outflow | 160 | 4.0 | 1.0 | 12.6 | 89.9 | 396.7 | 279.3 | 117.4 | Outflow to |
| from condenser to | | | | | | | | | gas |
| gas discharger) | | | | | | | | | discharger |
| S104 (Gas | 80 | 4.0 | 1.0 | 12.3 | 70.8 | 279.9 | 279.3 | 0.6 | Final gas |
| discharge from | | | | | | | | | discharge |
| desublimator) | | | | | | | | | stream |
| S105 (Liquid iodine | 80 | 4.0 | 0.0 | 4059.9 | 253.8 | 116.8 | — | 116.8 | Supplied to |
| discharge from | | | | | | | | | recirculation |
| desublimator, | | | | | | | | | line |
| inflow to | | | | | | | | | |
| recirculation line) | | | | | | | | | |
| S106 (Discharge | 160 | 4.0 | 0.0 | 3671.8 | 237.2 | 220.4 | 6.3 | 214.1 | Discharged |
| from condenser | | | | | | | | | to liquid |
| bottom through | | | | | | | | | iodine |
| liquid iodine | | | | | | | | | recovery |
| recovery reclaimer) | | | | | | | | | reclaimer |

As shown in Table 1, comparing data of S101 (reactor effluent inlet stream) and S102 (condenser inlet stream after cooling), it can be seen that the reactor effluent is cooled from about 525 °C to 160 °C through a heat exchanger before entering the condenser, and the pressure is adjusted from 5.0 kg/cm²g to 4.0 kg/cm²g, so that the reactor effluent is supplied under temperature and pressure conditions suitable for the condenser.

Comparing S103 (stream flowing to the upper gas discharger of the condenser) and S104 (stream flowing to the upper gas discharger of the desublimator), it can be seen that the stream discharged from the gas discharger of the condenser still contains a certain amount of iodine (reduced from 117.4 kg/hr to a level of 0.6 kg/hr), and the iodine remaining in the gas is additionally removed while passing through the desublimator. This shows that the desublimator actually recovers the remaining iodine as a liquid phase and supplies the same to the recirculation line.

S105 (stream flowing to the lower recirculation line of the desublimator) contains 116.8 kg/hr of Iodine (I₂) and is re-supplied to the upper portion of the condenser. This indicates that a structure for increasing iodine condensation efficiency in the packing section inside the condenser through a combination of the desublimator and the recirculation line actually operates.

In S106 (stream flowing to the liquid iodine recovery reclaimer at the bottom of the condenser), 214.1 kg/hr of Iodine (I₂) is discharged and non-condensable gas components are rarely included, which indicates that high-purity liquid iodine is directly recovered from the lower portion of the condenser.

As described above, the stream data presented in Table 1 according to the embodiment of the present disclosure shows that the structure in which the condenser, the gas discharger, the desublimator, the recirculation line, and the liquid iodine recovery reclaimer are systematically coupled to efficiently liquefy and recover iodine vapor is actually implemented.

According to an embodiment of the present disclosure, iodine condensation efficiency in the condenser is improved, iodine lost in the gas discharger is minimized, and additional heat exchange is performed inside the condenser through the recirculation line, thereby improving the iodine recovery rate.

As described above, the apparatus and method for iodine recovery according to an embodiment of the present disclosure may effectively recover iodine by liquefying and recovering the iodine, thereby reducing a burden on downstream equipment.

In addition, in the apparatus and method for iodine recovery according to an embodiment of the present disclosure, since the iodine recovered in the condenser exists in a liquid state, storage and transport thereof are facilitated compared to iodine recovered in a solid state, and the recovered iodine may be directly supplied to and utilized in a reuse process.

In addition, in the apparatus and method for iodine recovery according to an embodiment of the present disclosure, the recovery method using the condenser may provide a higher heat recovery rate than a solidification method. That is, in the case of recovering iodine as a solid, the reactor effluent must be cooled to about 40 °C-80 °C, but according to the embodiment of the present disclosure, since iodine is recovered as a liquid in the condenser, the reactor effluent only needs to be cooled to about 160 °C. Therefore, when supplying the reactor effluent to the reuse process later, an amount of heat required to raise the temperature may be reduced.

In addition, the apparatus and method for iodine recovery in an embodiment of the present disclosure may further improve the iodine recovery rate by installing the baffle and the packing section inside the condenser and mixing the liquid iodine supplied through the recirculation line with the reactor effluent to perform heat exchange with iodine vapor.

The above description is an illustration of applying the principles of the present disclosure, however, it is noted that other configurations may be further included without departing from the scope of the present disclosure. For example, at least some of the various embodiments of the present disclosure described above may be combined.

What is claimed is:

1. An apparatus for iodine recovery, comprising:
a condenser configured to cool a reactor effluent and separate the reactor effluent into liquid iodine and a gas;
a liquid iodine recovery reclaimer connected to a lower portion of the condenser and configured to recover the separated liquid iodine;
a gas discharger connected to an upper portion of the condenser and configured to discharge the separated gas;
a desublimator connected to the gas discharger; and
a recirculation line configured to re-supply liquid iodine recovered in the desublimator to the condenser.

2. The apparatus of claim 1, wherein the condenser includes a packing section formed therein, and wherein the reactor effluent and the liquid iodine supplied through the recirculation line contact each other in the packing section.

3. The apparatus of claim 2, wherein the packing section is disposed in a central portion of the condenser and is spaced apart from an inner wall of the condenser.

4. The apparatus of claim 2, wherein the condenser includes a baffle vertically installed inside the condenser adjacent to the packing section, and configured to partition a region where the liquid iodine inside the condenser collects and a region where the gas stays before being discharged to the gas discharger.

5. The apparatus of claim 4, wherein the baffle extends from the upper portion toward the lower portion inside the condenser, and defines a lower space spaced apart from a bottom region of the condenser.

6. The apparatus of claim 1, wherein the condenser includes a chimney tray formed in the upper portion of the condenser and configured to collect condensed liquid iodine, and further comprising a downcomer configured to guide the liquid iodine collected in the chimney tray to the bottom region of the condenser.

7. The apparatus of claim 1, wherein the liquid iodine recovery reclaimer includes a liquid iodine outlet connected to the bottom region of the condenser.

8. The apparatus of claim 1, wherein the gas discharger includes a gas outlet formed on an upper side surface of the condenser.

9. The apparatus of claim 1, wherein the desublimator is configured to recover iodine remaining in the gas supplied from the gas discharger as liquid iodine, and to supply the recovered liquid iodine to the recirculation line.

10. The apparatus of claim 1, wherein the recirculation line is a pipe connecting a lower outlet of the desublimator and an upper inlet of the condenser.

11. A method for iodine recovery, the method comprising:
cooling a reactor effluent in a condenser to separate the reactor effluent into liquid iodine and a gas;
recovering the separated liquid iodine through a liquid iodine recovery reclaimer connected to a lower portion of the condenser;
discharging the separated gas through a gas discharger connected to an upper portion of the condenser;
recovering iodine remaining in the gas as liquid iodine in a desublimator connected to the gas discharger; and
re-supplying the liquid iodine recovered in the desublimator to the condenser through a recirculation line.

12. The method of claim 11, wherein cooling the reactor effluent in a condenser to separate the reactor effluent into liquid iodine and a gas comprises:
contacting the reactor effluent with the liquid iodine supplied through the recirculation line in a packing section formed inside the condenser and accommodating a plurality of packing materials.

13. The method of claim 12, further comprising partitioning a region where the liquid iodine inside the condenser collects and a region where the gas stays before being discharged to the gas discharger using a baffle vertically installed inside the condenser adjacent to the packing section.

14. The method of claim 13, wherein the baffle extends from the upper portion toward the lower portion inside the condenser to define a lower space spaced apart from a bottom region of the condenser, and further comprising flowing the gas to the gas discharger through the lower space of the baffle.

15. The method of claim 11, wherein recovering the separated liquid iodine through a liquid iodine recovery reclaimer connected to a lower portion of the condenser comprises:
discharging the liquid iodine through a liquid iodine outlet formed in a bottom region of the condenser.

16. The method of claim 12, wherein re-supplying the liquid iodine recovered in the desublimator to the condenser through a recirculation line comprises:
supplying the liquid iodine to the packing section inside the condenser through the recirculation line connecting a lower outlet of the desublimator and an upper inlet of the condenser.

17. The method of claim 11, wherein the condenser includes a chimney tray formed in the upper portion of the condenser and configured to collect condensed liquid iodine, and further comprising guiding the liquid iodine collected in the chimney tray to a bottom region of the condenser through a downcomer to discharge the liquid iodine.
